(19) United States
(12) Patent Application Publication
(10) Pub. No.: US 2009/0112131 A1
(43) Pub. Date: Apr. 30, 2009

(54) BODY SCULPTING DEVICE AND BODY SCULPTING SYSTEM USING THE SAME

(76) Inventor: Hong-Jik DOO, SEOUL (KR)

Correspondence Address: IPLA P.A., 3580 WILSHIRE BLVD., 17TH FLOOR, LOS ANGELES, CA, 90010, US

(21) Appl. No.: 12/206,119

(22) Filed: Sep. 8, 2008

(30) Foreign Application Priority Data
Oct. 31, 2007 (KR) 10-2007-0110080
Oct. 31, 2007 (KR) 20-2007-0017608
Oct. 31, 2007 (KR) 20-2007-0017609
Oct. 31, 2007 (KR) 20-2007-0017610
Oct. 31, 2007 (KR) 20-2007-0017611
Apr. 11, 2008 (KR) 10-2008-0033486

(51) Int. Cl. A61H 1/00

(52) U.S. Cl. 601/2

(57) ABSTRACT

A body sculpting device and a body sculpting system are disclosed which can sculpt body areas, such as the abdomen, thighs, arms, etc., by burning fat stored in the body and massage the face and the soles of the feet, according to a use's selection. The body sculpting system includes a control box, a stand, an obesity management unit, and a probe.

### CROSS REFERENCES

This application claims foreign priority under Paris Convention and 35 U.S.C. § 119 to Korean Patent Application Nos. 10-2008-0033486 filed 11 Apr. 2008, 10-2007-0110080 filed 31 Oct. 2007, 20-2007-0017608 filed 31 Oct. 2007, 20-2007-0017609 filed 31 Oct. 2007, 20-2007-0017610 filed 31 Oct. 2007, 20-2007-0017611 filed 31 Oct. 2007, each with the Korean Intellectual Property Office.

### BACKGROUND OF THE INVENTION

1. Field of the Invention

The present invention relates to body sculpting technology, and more particularly, to a body sculpting device and a body sculpting system that can sculpt a body, including areas such as the abdomen, thighs, arms, etc., by burning fat stored in the body and also massage the face and soles of the feet, according to a user's selection, in which the body sculpting system includes a control box, a stand, an obesity management unit, and a probe.

2. Description of the Related Art

In general, obesity is a condition in which excessive adipose tissue has accumulated on a body and usually concerns persons with a body fat of 20% above the recommended body fat percentage with regard to the average weight for a predetermined height and age. For example, a man is obese when his body fat percentage is 20% above a predetermined maximum weight. A woman is obese when her body fat percentage is 30% above her weight. Obesity can be classified in a variety of ways based on causes of obesity. Adipose tissue is mainly accumulated in a person's abdomen, thighs, and arms.

In order to burn the fat in the body, a conventional apparatus for burning fat includes a low frequency generator having a pad and a belt in which the low frequency generator is installed while a user wears the belt on a portion of their body. The low frequency generator is controlled by an external controller.

Although the conventional low frequency generator can burn the fat in the user's body, the conventional pad of the low frequency generator is disadvantageous in that, since the pad must be inserted to an additionally manufactured belt, which is closely attached to a corresponding part of the user's body, the pad can be relocated to other parts of the user's body from the corresponding part, or removed therefrom, by even the slightest movement by the user. Therefore, the user must lie in a stationary position in order to use the conventional apparatus for burning fat.

Also, since the conventional low frequency generator of a pad type is separated from the belt, a user has difficulty when using this device. In addition, since only the conventional low frequency generator itself is operated to burn body fat, a user does not receive effective treatment for obesity.

### SUMMARY OF THE INVENTION

The present invention solves the above problems, and provides a body sculpting device and a body sculpting system having the same, which can sculpt body parts, such as the abdomen, thighs, arms, etc., by burning fat stored in the body and massage the face and soles of the feet, according to a use's selection, in which the body sculpting system includes a control box, a stand, an obesity management unit, and a probe.

In accordance with an exemplary embodiment of the present invention, the present invention provides a body sculpting device including: a control box that includes a cover, a small-sized auxiliary cover installed on the front of the cover, and a control unit that is exposed when the auxiliary cover is opened from the cover, the control box controlling a plurality of elements through the control unit electrically connected thereto; a stand that includes a mid-frequency generator installed to foot plates on which user's soles are placed, the stand allowing the mid-frequency generator to stimulate the user's soles when a connector, electrically connected to the mid frequency generator, is connected to a coupling unit formed at the rear of the control box; an obesity management unit that includes amid-low-frequency generator and an ultra-sonic generator which are installed to the front of a synthetic resin plate shaped as a plate by an ejection method, the obesity management unit, electrically connected to the control unit of the control box, burning fat in the user's abdomen, thighs, arms, etc. and promoting blood circulation; and a probe that includes an ultra-sonic generator installed on its upper end and a vibration motor installed within its body, the probe, electrically connected to the control box, massaging the user's face by using the ultra-sonic generator or the vibration motor.

In accordance with another exemplary embodiment of the present invention, the present invention provides a body sculpting system including: a key controller, wherein the key controller includes a controller that determines whether a channel is selected through the key matrix part and whether the selected channel is operated, inputs a key value from the key matrix part and displays a corresponding state of the display part, controls driver controllers of respective drives included in a drive unit, and transmits digital signals output from the outside to the display part to display output values in real-time; a storage unit for storing a body sculpting program; a main controller that determines whether a key input corresponds to a signal to select one of four channels, reads, in a negative feedback manner, whether a frequency generated through the selected channel is selected and performs a negative-feed back control so that the selected frequency can be generated through the selected channel, determines a mode selected by a user to read the selected mode from the storage unit and performs a controlling operation so that the whole system can be driven to the corresponding mode; a drive unit that drives two of four pads associated with channel (1) to generate the fixed frequency of 4 kHz according to the control of the main controller, varies the duty rate and amplitude, according to the program stored in the storage unit, to drive the remaining two pads associated with channel (1) to generate free waves, or drives four pads to output interference waves; an ultra-sonic controller that outputs the interference waves or free waves to channel (1) according to the frequency output from the drive unit; and a sub-controller that provides only the free waves to channels (2A, 2B, and 3) with respect to the frequency signal output from the drive unit.

### BRIEF DESCRIPTION OF THE DRAWINGS

The features and advantages of the present invention will be more apparent from the following detailed description in conjunction with the accompanying drawings, in which:

FIG. 1 is a perspective view depicting a control box according to the present invention, in which an auxiliary cover is opened;

FIG. 2 is a perspective view depicting a control box according to the present invention, in which a cover is opened;

FIG. 3 is a view depicting a use state of a control box according to the present invention;

FIG. 4 is a perspective view depicting a stand according to the present invention;

FIG. 5 is a perspective view depicting the control box placed on the stand, according to the present invention;

FIG. 6 is an exploded front perspective view depicting an obesity management unit according to the present invention;

FIG. 7 is an exploded rear perspective view depicting the obesity management unit according to the present invention;

FIG. 8 is a perspective view depicting the rear of the obesity management unit according to the present invention;

FIG. 9 is a plan view illustrating the obesity management unit according to the present invention;

FIG. 10 is a perspective view depicting a probe according to the present invention;

FIG. 11 is a perspective view depicting the probe according to the present invention, in which an upper cover is coupled to the probe;

FIG. 12 is an exploded perspective view depicting the probe according to the present invention;

FIG. 13 is a schematic block diagram illustrating a body sculpting system according to the present invention;

FIG. 14 to FIG. 16 are flow charts describing an operation method of the body sculpting system according to the present invention;

FIG. 17 is a view illustrating a display panel and a key panel;

FIG. 18 is a view describing an interference wave adapted to the present invention; and

FIG. 19 is a view describing a free wave adapted to the present invention.

### BRIEF DESCRIPTION OF SYMBOLS IN THE DRAWINGS

100: obesity management unit
200: control box
300: probe
400: stand

### DETAILED DESCRIPTION OF EXEMPLARY EMBODIMENTS

Hereinafter, exemplary embodiments of the present invention are described in detail with reference to the accompanying drawings. The same reference numbers are used throughout the drawings to refer to the same or similar parts. Detailed descriptions of well-known functions and structures incorporated herein may be omitted to avoid obscuring the subject matter of the present invention.

The embodiment of the present invention is described starting from a body sculpting device and then a body sculpting system incorporating the body sculpting device.

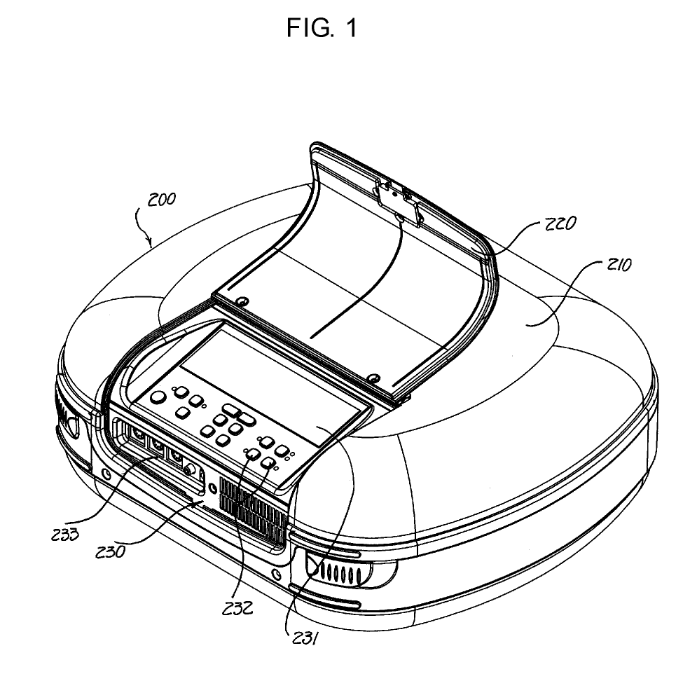

As shown in FIG. 1 to FIG. 12, the body sculpting device according to the present invention includes a control box 200, a stand 400, an obesity management unit 100, and a probe 300.

The control box 200 includes a cover 210, a small-sized auxiliary cover 220 installed on the front of the cover 210, and a control unit 230 that is exposed when the auxiliary cover 220 is opened from the cover 210. The control box 200 controls a plurality of elements through the control unit 230 which is electrically connected thereto. The stand 400 is configured in such way that a mid-frequency generator 420 is attached to foot plates 470 on which the soles of the user's feet are placed. When a connector 450, electrically connected to the mid frequency generator 420, is connected to a coupling unit 201 formed at the rear of the control box 200, the stand 400 stimulates the user's soles using the mid-frequency generator 420. The obesity management unit 100 is configured in such a way that a mid-low frequency generator 120 and an ultra-sonic generator 140 are attached to the front of a synthetic resin plate 110 shaped as a plate by an ejection method. The obesity management unit 100, electrically connected to the control unit 230 of the control box 200, burns fat in the user's abdomen, thighs, arms, etc. and promotes blood circulation. The probe 300 includes an ultra-sonic generator 310 installed on its upper end and a vibration motor 320 installed within its body. The probe 300, electrically connected to the control box 200, massages the user's face by using the ultra-sonic generator 310 or the vibration motor 320.

In the following description, the configuration and operation of each element of the body sculpting device is explained in detail with reference to the drawings.

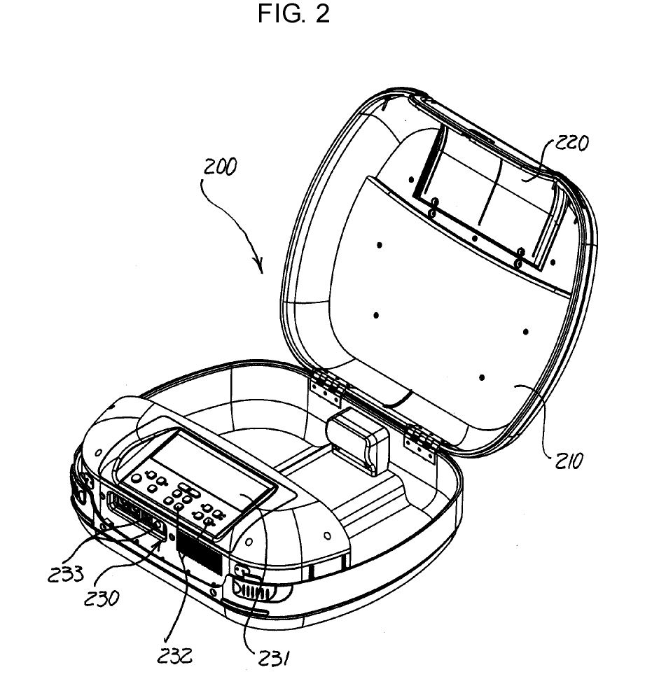

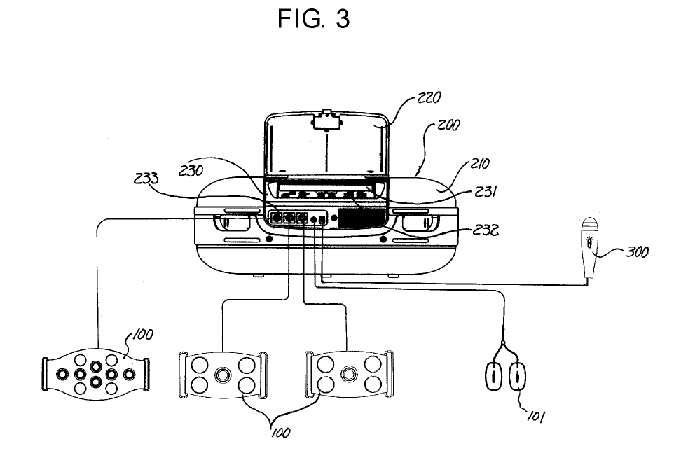

FIG. 1 is a perspective view depicting a control box 200 according to the present invention, in which an auxiliary cover is opened. FIG. 2 is a perspective view depicting a control box 200 according to the present invention, in which a cover is opened. FIG. 3 is a view depicting a use state of a control box 200 according to the present invention.

As shown in FIG. 1 to FIG. 3, the control box 200 is shaped in the form of a suitcase, and serves to control various electrical mechanisms, such as the obesity management unit, probe, and pads, etc. through the control unit 230 installed thereto.

The control box 200 has a cover 210 on which an auxiliary cover 220 is formed. When the auxiliary 220 is opened in a state where the cover 210 closes the control box 200, the control unit 230, including a display window 231, function buttons 232, and connection terminals 233, is exposed.

The control unit 230 is installed on the front side of the control box 200 so that it can be exposed to the outside when the auxiliary cover 220 is opened. More specifically, when the auxiliary cover 220 is opened, the control unit 230 is exposed in such a way that: the display window 231 and function buttons 232 are exposed on the upper side; and the connection terminals 233 are exposed on the side face. The display window 231 is formed on the top portion and the function buttons 232 are formed under the display window 231. The connection terminals 233 are electrically connected to the obesity management unit 100, probe 300, and pads 101, which stimulate user's body.

The control box 200 keeps the obesity management unit 100, probe 300, and pads 101 in its internal space as the cover 210 is closed.

In order to use the body sculpting device, the cover 210 is opened so that the obesity management unit 100, probe 300, and pads 101 are taken out from the control box 200, and then closes the control box 200, again. After that, the auxiliary cover 220 is opened to expose the control unit 230 to the outside. Next, the obesity management unit 100, probe 300, and/or pads 101 are connected to the connection terminals 233.

For example, a user wears the obesity management unit 100 on the abdomen, thighs, arms, etc., in which the obesity management unit 100 is configured to be small-, mid-, or large-sized. The pads 101 are used to contact areas of user's body to which the obesity management unit 100 cannot be applied. Also, the probe 300 is used to massage areas of the user's body, such as the face, etc.

When the control box 200 is turned on, the temperature, time, intensity, etc. can be set by using the function buttons 232. The display window 231 displays the current operation of the control box 200 thereon.

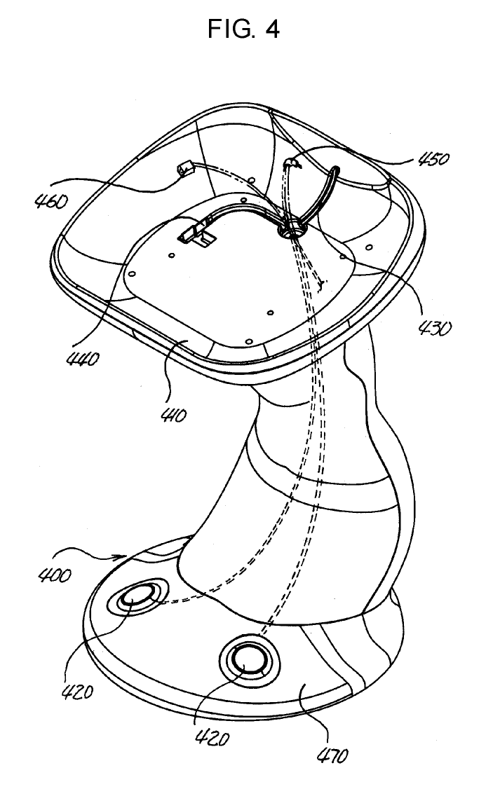

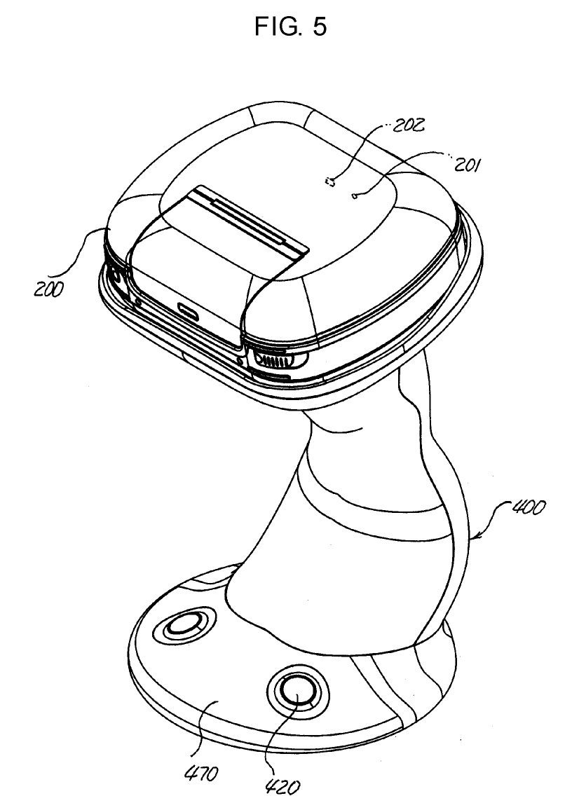

FIG. 4 is a perspective view depicting a stand according to the present invention. FIG. 5 is a perspective view depicting the control box placed on the stand, according to the present invention.

As shown in FIG. 4 to FIG. 5, the stand 400 is configured in such a way that: mid-frequency generators 420, spaced apart from each other at a certain distance, are installed at left and right sides of the foot plate 470 placed at the lower part and these stimulate the soles of the user's feet; a connector 450 is electrically connected at one end to the mid-frequency generators 420 and at the other end to the control box 200, so that the control box 200 can control the mid-frequency generators 420; an interference protection groove 430 is formed at the rear side on the bottom of a support 410 placed at the upper part so as to prevent the connector 450 from being damaged when the control box 200 is placed on the support 410 in a state where the connector 450 is electrically connected to the control box 200; and a reserved interference protection groove 440 is formed at the middle portion on the bottom of the support 410 so as to prevent the connector 450 from interfering with the outside when the connector 450 is separated from the control box 200.

A main power line 460 is electrically connected to a main coupling unit 202 formed at the rear side of the control box 200 so as to supply electric power to the control box 200.

The mid-frequency generators 420, formed at the right and left sides on the foot plate 470 of the stand 400, are electrically connected to the connector 450. The connector 450 and the main power line 460 are inserted into and stored in the reserved interference protection groove 440. That is, since the connector 450 and the main power line 460, stored in the reserved interference protection groove 440, are not exposed to the outside, they do not cause any interference with external devices and thus cannot be damaged.

The connector 450 and the main power line 460 are positioned at the interference protection groove 430 and the control box 200 is then placed on the support 410.

The connector 450 and the main power line 460 are connected to the coupling unit 201 and the main coupling unit 202, correspondingly and respectively. When the control box 200 is turned on, it inputs electric power through the main power line 460. When soles of the user's feet are placed on the mid-frequency generators 420, the mid-frequency generators 420 stimulate the soles of the user's feet and promote blood circulation, so that the user can keep their feet in good condition.

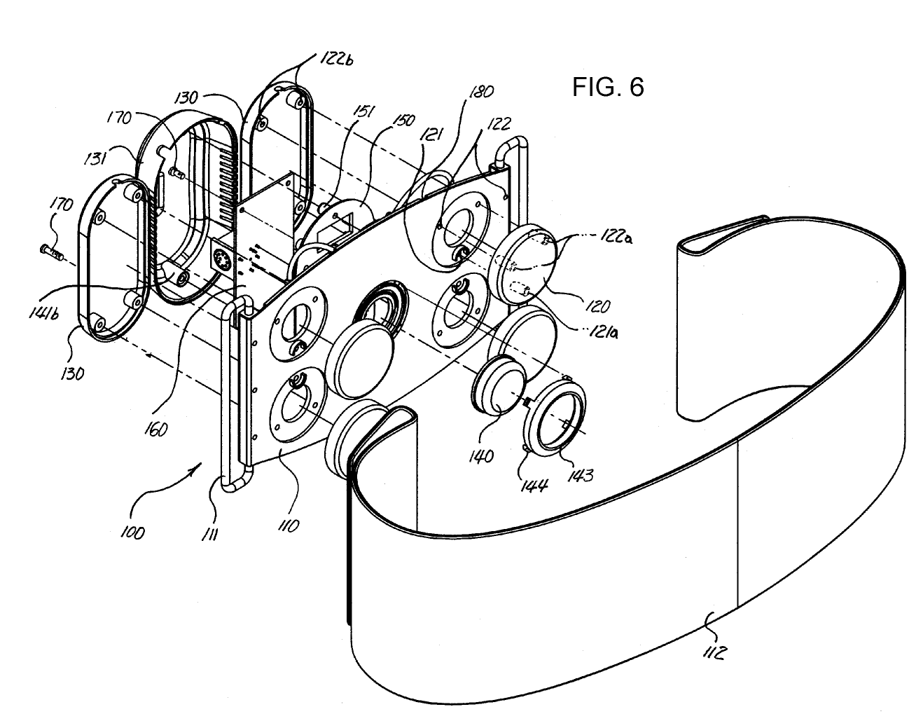

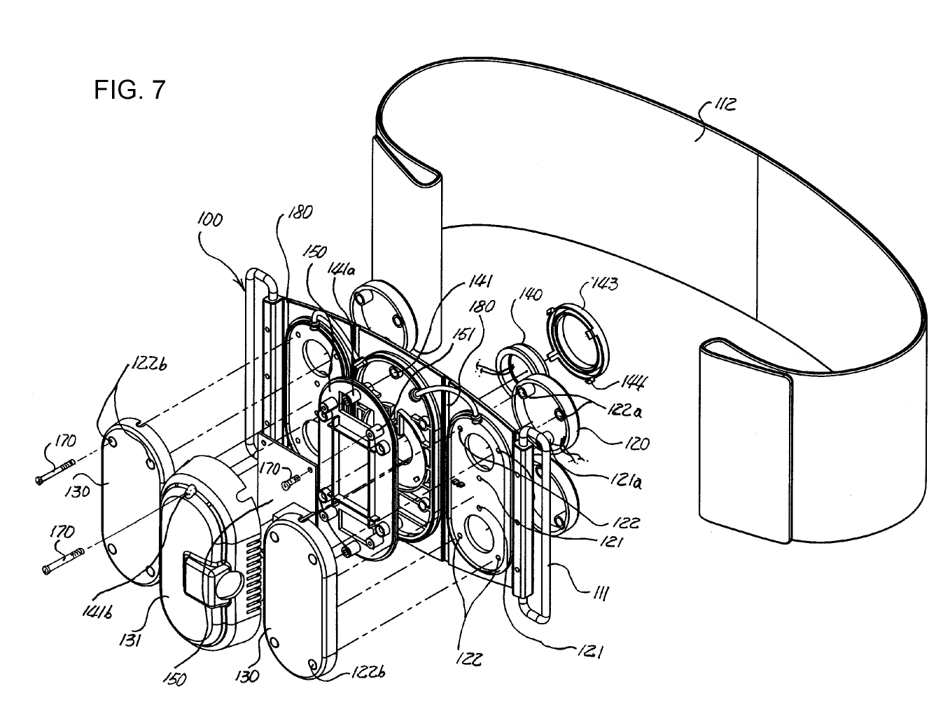

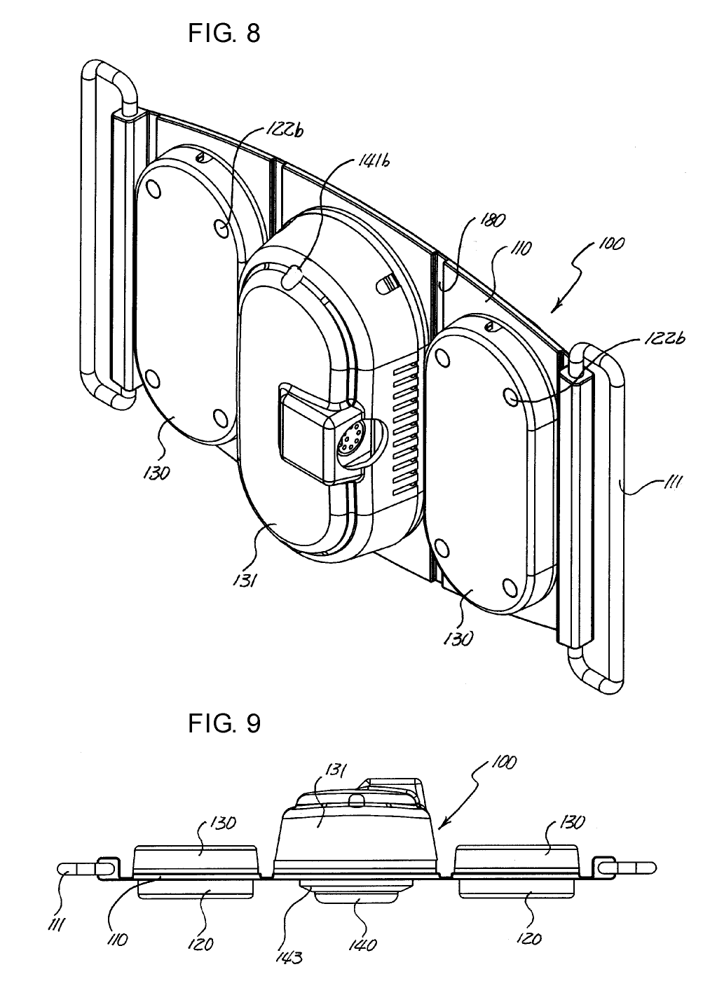

FIG. 6 is an exploded front perspective view depicting an obesity management unit according to the present invention. FIG. 7 is an exploded rear perspective view depicting the obesity management unit according to the present invention. FIG. 8 is a perspective view depicting the rear of the obesity management unit according to the present invention. FIG. 9 is a plan view illustrating the obesity management unit according to the present invention.

As shown in FIG. 6 to FIG. 9, an obesity management unit 100 is placed on the user's abdomen, thighs, and arms. The obesity management unit 100 includes mid-low frequency generators 120 and an ultra-sonic generator 140 whose one sides (one side of each) contact the user's body and whose opposite sides are protruded towards the outside from the user's body side. The mid-low frequency generators 120 and an ultra-sonic generator 140 contact the user's body, burn fat, and promote blood circulation. Both sides of the obesity management unit 100 are coupled to a belt 112 to make it comfortable for a user to wear the device.

The obesity management unit 100 includes a synthetic resin plate 110 of a certain size. The synthetic resin plate 110 is shaped into a plate form by injection molding. The synthetic resin plate 110 is configured in such a way that: a coupling groove 121 for a mid-low frequency generator and coupling grooves 122 for protection covering, which are extended through the body of the synthetic resin plate 110 and formed at both left and right sides of the synthetic resin plate 110; a locking groove 142 for an ultra-sonic generator and a coupling part 141 for protection covering, which are formed on the front and rear sides at the middle portion of the synthetic resin plate 110; the mid-low frequency generator 120 and the ultra-sonic generator 140 are detachably assembled to the front of the synthetic resin plate 110 through the coupling groove 121 for the mid-low frequency generator and the coupling grooves 122 for ultra-sonic generator; and protection covers 130 and 131 are detachably assembled to the rear side of the synthetic resin plate 110, so that the protection covers 130 and 131 can protect the insides of the mid-low frequency generator 120 and the ultra-sonic generator 140 through the coupling grooves 122 for protection covering and the coupling part 141 for protection covering.

When the synthetic resin plate 110 is fabricated using injection molding via an injection molder, the coupling groove 121 for the mid-low frequency generator, the coupling grooves 122 for ultra-sonic generator, the locking hole 142 for an ultra-sonic generator, the coupling part 141 for protection covering, and folding grooves 180 are formed in the synthetic resin plate 110. As the injection molder is well known in this art, its detailed description is omitted in the application.

The coupling groove 121 for the mid-low frequency generator and the coupling grooves 122 for ultra-sonic generator are located at both the right and left sides of the synthetic resin plate 110 and extended through the body of the synthetic resin plate 110. The mid-low frequency generator 120 forms a coupling hole 121a and coupling holes 122a that correspond to the coupling groove 121 for the mid-low frequency generator and the coupling grooves 122 for ultra-sonic generator, respectively. Also, coupling holes 122b for protection covering, corresponding to the coupling grooves 122, are formed at the upper portion and lower portion of the protection cover 130.

The locking grooves 142 for an ultra-sonic generator are formed at the center portion at the front of the synthetic resin plate 110. The coupling parts 141 for protection covering are formed at the upper portion and lower portion at the rear side of the synthetic resin plate 110. The locking grooves 142 are coupled to locking protrusions 144 of a fixing cap 143, so that the ultra-sonic generator 140 is fixed to the front of the synthetic resin plate 110. Coupling holes 141b for protection covering are formed at the upper portion and lower portion of the protection cover 131, which protects the inside of the ultra-sonic generator 140. The coupling holes 141b are located at the same position as the coupling parts 141.

The folding grooves 180 are vertically formed at the rear side of the synthetic resin plate 110. The folding grooves 180 are spaced a certain distance apart from each other. The folding grooves 180 allow the synthetic resin plate 110 to be naturally bent to follow the user's body shape.

A circuit board 160 is integrally attached to the body of the synthetic resin plate 110 and electrically connected to the control box (not shown), so that it can control the obesity management unit 100. More specifically, the circuit board 160 is installed to the synthetic resin plate 110 in such a way that: the circuit board 160 is fixed to the front of a board coupling body 150 as coupling members 170 are coupled to board connection parts 151; and coupling units 141a, formed at the upper and lower portions of the board coupling body 150, are aligned with the coupling parts 141 for protection covering and the coupling holes 141b for protection covering and then coupled to the rear side of the synthetic resin plate 110 by the coupling members 170.

Here, the coupling members, labeled by reference number 170, are used to fix the ultra-sonic generator 140, mid-low frequency generator 120, protection covers 130 and 131, circuit board 160, and board coupling member 150 to the front or rear sides of the synthetic resin plate 110.

The ultra-sonic generator 140 and mid-low frequency generator 120 are electrically connected to the circuit board 160 that is electrically connected to the control box 200 used for the body sculpting device.

In addition, a coupling clip 111 is attached to both sides of the synthetic resin plate 110 and coupled with the belt 112.

The obesity management unit 100 is fabricated as follows.

The coupling groove 121 for mid-low frequency generator, coupling though-holes 122 for an ultra-sonic generator, locking groove 142 for an ultra-sonic generator, coupling part 141 for protection covering, and folding grooves 180 are formed in the synthetic resin plate 110 when the synthetic resin plate 110 is fabricated. The protection covers 130 131, ultra-sonic generator 140, mid-low-frequency generator 120, board coupling body 150, circuit board 160, and belt 112 are prepared, respectively.

After that, the coupling holes 121a of the mid-low-frequency generator 120 are located at the coupling grooves 121 formed at both the right and left sides of the synthetic resin plate 110. The coupling holes 122b are also located at the coupling grooves 122. In this stage, the coupling holes 121a are coupled to the coupling grooves 121 by the coupling members 170 used as a screw, so that the mid-low frequency generator 120 is attached to the front of the synthetic resin plate 110.

When the mid-low frequency generator 120 is attached to the front of the synthetic resin plate 110, the coupling holes 122b, formed at the upper and lower portions of the protection cover 130, are aligned the coupling groove 122 and the coupling holes 122a. After that, the coupling members 170 screw together the coupling holes 122b, coupling grooves 122, and coupling holes 122a. As a result, the protection cover 130 is firmly installed to the rear side of the synthetic resin plate 110 and accordingly the inside of the mid-low-frequency generator 120 is protected. Here, the mid-low-frequency generator 120 is tightly secured to the front side of the synthetic resin plate 110.

In order to assemble the ultra-sonic generator 140 to the front side of the synthetic resin plate 110, the ultra-sonic generator 140 is inserted into the fixed cap 143 and then the locking protrusions 144 are firmly inserted into the locking grooves 142, thereby locking the locking protrusions to the inside of the locking grooves 142.

When the ultra-sonic generator 140 is assembled, the circuit board 160 is integrally fixed to the board coupling body 150 by the board connection parts 151, formed at the upper and lower portions of the board coupling body 150. The coupling unit 141a and the coupling holes 141b are also aligned with the coupling parts 141. After that, they are fixed to the rear side of the synthetic resin plate 110 by the coupling members 170.

Next, both ends of the belt 112 are coupled to the coupling clips 111 of the obesity management unit 100, respectively. When a user wears the obesity management unit 100, the obesity management unit 100 is curved through the folding grooves 180 and closely attached to the user's body. When the user wears the obesity management unit 100 and turns on the power switch, the mid-low-frequency generator 120 and ultra-sonic generator 140 operate to burn fat and promote blood circulation.

The obesity management unit 100 is advantageous in that, when it needs to be repaired only the malfunctioning parts need to be dissembled and fixed.

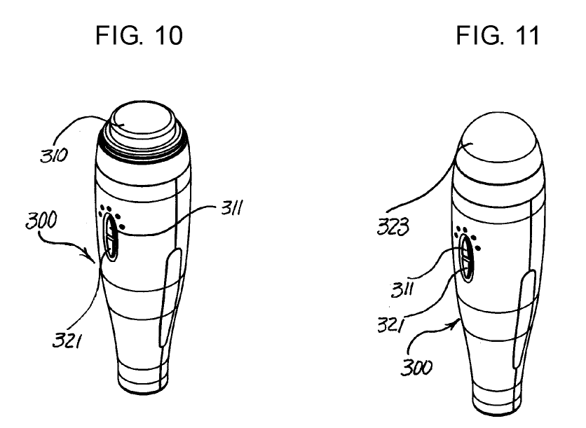

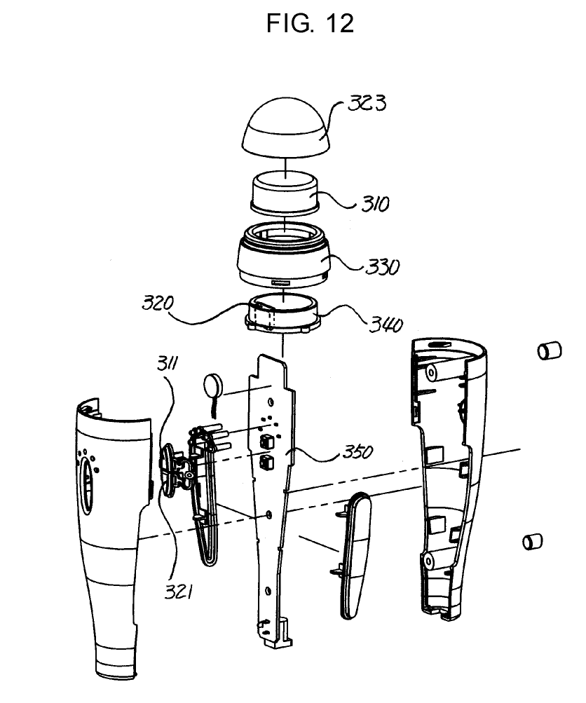

FIG. 10 is a perspective view depicting a probe according to the present invention. FIG. 11 is a perspective view depicting the probe according to the present invention, in which an upper cover is coupled to the probe. FIG. 12 is an exploded perspective view depicting the probe according to the present invention.

As shown in FIG. 10 to FIG. 12, the probe 300 includes an ultra-sonic generator 310, a vibration motor 320, and a cap 323. The probe 300 operates its ultra-sonic generator 310 or the vibration motor 320 according to whether the ultra-sonic function or vibration function is selected.

The ultra-sonic generator 310 is placed at the upper end of the probe 300. The ultra-sonic generator 310 massages the user's face when the ultra-sonic operation button 311, installed to the outer body of the probe 300, is switched on.

The vibration motor 320 is installed in the body of the probe 300. When the vibration operation button 321 is switched on, the ultra-sonic generator 310 massages the user's face through the cap 323 placed on the upper end thereof.

The ultra-sonic generator 310 is inserted into and fixed to a head 330 placed at the upper end of the probe 300 and protruded to the outside. The vibration motor 320 is fixed to the body of the probe 300 through a support 340 that is fixed in the body of the probe 300. The support 340 supports and holds the vibration motor 320 and supports the lower end of the ultra-sonic generator 310 so that the ultra-sonic generator 310 cannot be lowered.

Here, the ultra-sonic generator 310 and vibration motor 320 are electrically connected to the circuit board 350 that is electrically connected to the control box 200.

When the ultra-sonic operation button 311 is switched on in order to use an ultra-sonic function of the probe 300, the ultra-sonic generator 310 operates and generates ultra-sonic waves. While the ultra-sonic generator 310 is operating, it contacts and massages the user's face though the generated ultra-sonic waves.

In order to use the vibration function, the cap 323 is coupled to the upper end of the probe 300 and then the vibration button 321 is switched on, so that the vibration motor 320 is operated. While the vibration motor 320 is operating, it contacts and massages the user's face through the generated vibration.

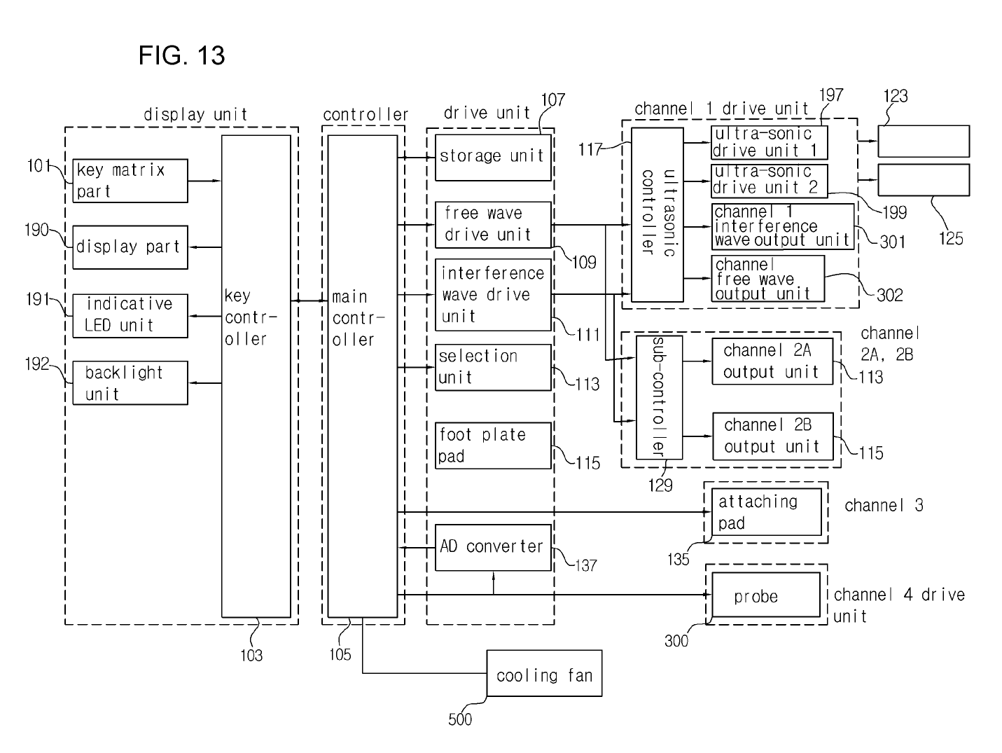

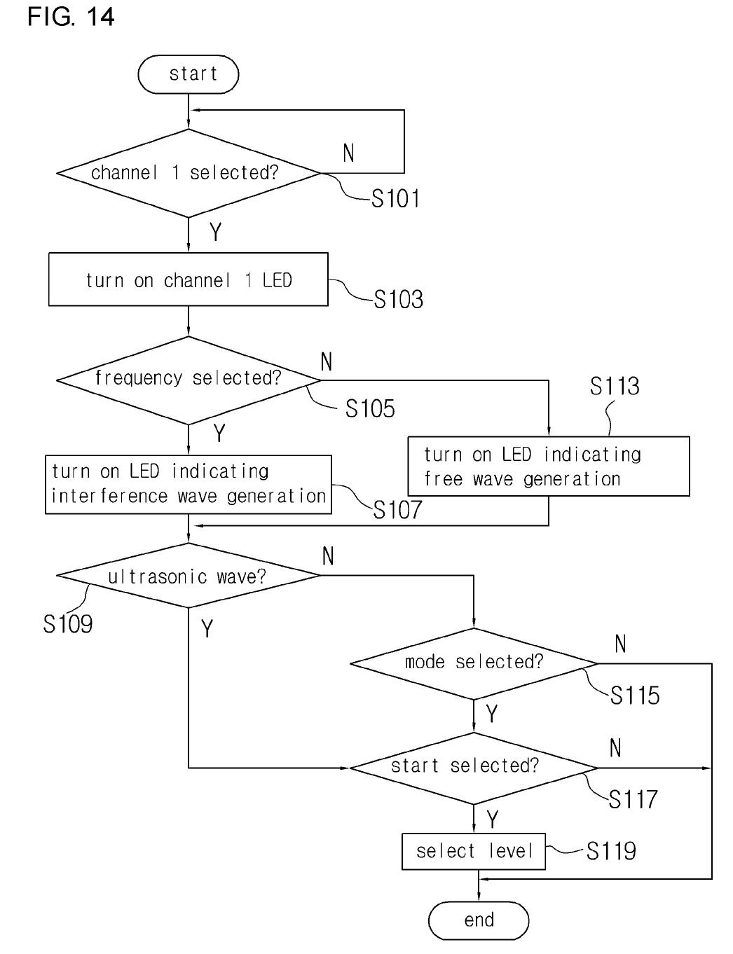

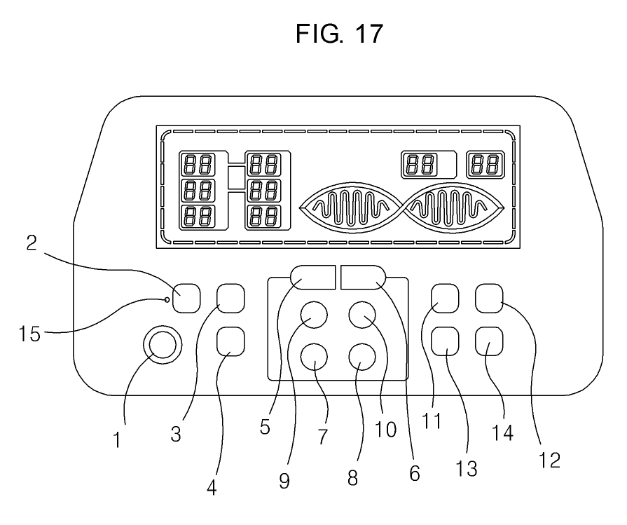

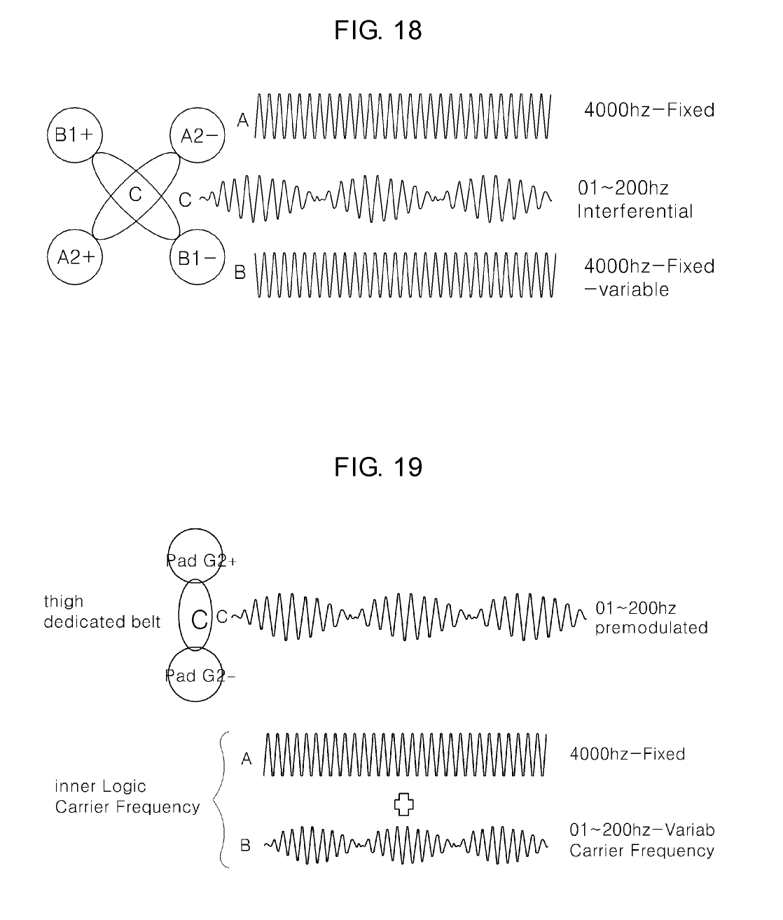

FIG. 13 is a schematic block diagram illustrating a body sculpting system according to the present invention. FIG. 14 to FIG. 16 are flow charts describing an operation method of the body sculpting system according to the present invention. FIG. 17 is a view illustrating a display panel and a key panel. FIG. 18 is a view describing an interference wave adapted to the present invention. FIG. 19 is a view describing a free wave adapted to the present invention.

The body sculpting system is configured to include: a key controller 103; a storage unit 107 for storing a body sculpting program; a main controller 105; a drive unit; an ultra-sonic controller 117; a sub-controller 129; and cooling fan 500.

The key controller 103 is connected to a key matrix part 101, a display part 190, an indicative LED unit 191, and a backlight unit 192. The key controller 103 includes a controller that determines whether a channel is selected through the key matrix part 101 and whether the selected channel is operated. The key controller 103 inputs a key value from the key matrix part 101 and displays the corresponding state of the display part 190. The key controller 103 controls driver controllers (not shown) of respective drives included in a drive unit (which will be described later). The key controller 103 transmits digital signals output from the main controller 105 to the display part 190 to display output values, which are changed, in real-time.

The main controller 105 determines whether a key input corresponds to a signal and then selects one of four channels. The main controller 105 reads, in a negative feedback manner, whether a frequency generated through the selected channel is selected and performs a negative-feed back control so that the selected frequency can be generated through the selected channel. The main controller 105 determines a mode selected by a user, reads the selected mode from the storage unit 107, and performs a controlling operation so that the whole system can be driven to the corresponding mode.

The drive unit drives two of four pads associated with channel 1 to generate a fixed frequency of 4 kHz, according to the control of the main controller 105, varies the duty rate and amplitude, according to the program stored in the storage unit 107, to drive the remaining two pads associated with channel 1 to generate free waves, or drives four pads to output interference waves.

The ultra-sonic controller 117 outputs the interference waves or free waves to channel 1 according to the frequency output from the drive unit.

The sub-controller 129 provides only the free waves to channels 2A, 2B, and 3 with respect to the frequency signal output from the drive unit.

In the following description, the above elements are described in detail.

The drive unit includes: a free wave drive unit 109 for varying the duty rate and amplitude of the free wave signal, according to the control of the main controller 105; and an interference wave drive unit 111 for generating interference waves, according to the control of the main controller 105.

The ultra-sonic controller 117 is operated in such a way that: interference waves are generated through the frequency difference that is generated by the beat frequency of interference waves generated at the four pads of channel 1 from the interference wave drive unit 111, according to the control of the main controller 105; and the interference waves are output to the pads through a channel 1 interference wave output unit 301 so as to be provided with channel 1. Also, the ultra-sonic controller 117 is operated in such a way that: the duty rate and amplitude of the free wave signal according to the body sculpting program stored in the storage unit 107 to generate free waves at two pads of channel 1; and the free waves are output to the pads through channel 1 free wave output unit 302 so as to be provided with channel 1. In addition, the ultra-sonic controller 117 is operated in such a way that: when channel 1 and an ultra-sonic wave function are selected through the key controller 103, the ultra-sonic controller 117 having an additional microcomputer performs corresponding controlling operations, and ultra-sonic drive unit 1 197 and an ultra-sonic drive unit 199 drive a vibrator 1 (123) and a vibrator 2 (125) so that they oscillate and simultaneously output ultrasonic waves.

Channel 1 produces interference waves as a fixed frequency of 4,000 Hz is provided to its one side and a wave of 4,000˜4,170 Hz changes its duty rate and amplitude on the other side.

Channel 1 or channel 2, composed of channel 2A and channel 2B, output low-frequency waves that are sinusoidal waves converted from digital signals, so that the low-frequency waves do not irritate the user's skin.

When the main controller 105 is switched on, it determines whether the cooling fan 500 is connected thereto. When the cooling fan 500 is connected, the main controller 105 controls the whole system so that the body sculpting device can be operated. The body sculpting device according to the present invention reduces inner heat, so that it can be operated in a stable manner.

When a channel selection signal is input, the main controller 105 determines whether the belt is coupled thereto. When the belt is coupled thereto, the main controller 105 allows the body sculpting device to operate. The main controller 105 checks whether the belt is coupled thereto during the operation of the body sculpting device. When the main controller 105 detects that the belt is released therefrom, it stops the operation of the body sculpting device.

When the user selects an automatic level mode, the main controller 105 sequentially and automatically performs from level 1 to level 15. On the contrary, when the user selects a manual level mode, the main controller 105 allows the user to select one of 18 levels. That is, the body sculpting device can be set up and operated according to use's selection. The body sculpting device also allows the user to alter the program that is programmed for the levels. In addition, the body sculpting device stores input values set according to user's selection, so that the user can use the stored input values at a later date. Furthermore, the body sculpting device can be reset to the initial state when it was first manufactured.

The main controller 105 manages the mode information of the body sculpting program stored in the storage unit 107.

As shown in FIG. 17, the key matrix part 101 includes a power ON/OFF key 1, ON/OFF selection key 2 of CH 1 for interference waves, ON/OFF selection key 3 of CH 1˜CH 3 for low frequency waves, mode selection key 4 (MODES A˜F), down key 5, up key 6, hold key 7, start key 8, time set-up key 9, ultra-sonic wave setting key 10, ON/OFF selection key 11 of CH 1 (abdomen), selection key 12 of CH 2 (thighs A, B), ON/OFF selection key 13 of pads and foot plates, and probe ON/OFF selection key 14.

The power ON/OFF key 1 serves to turn the power on or off and to keep the body sculpting device on standby (LEVEL 0).

The ON/OFF selection key 2 of CH 1 for free waves is set so that the body sculpting device can be operated in 6 modes, A, B, C, D, E, and F. Here, the free interference can be output as only channel 1 is selected. That is, the output of interference waves cannot be selected by other channels except for channel 1.

The ON/OFF selection key 3 of CH 1˜CH 3 for low frequency waves is set in such way that: CH 2 and CH 3 can be selected to output only free waves and CH 1 can be selected to output interference waves, free waves, and ultra-sonic waves, according to the selection of 6 modes (A˜F).

The mode ON/OFF selection key 4 allows a user to select one of 6 modes A˜F at each channel and can also be changed to a desired mode through rotation flow.

The down key 5 and up key 6 serve to set time and levels and are also used in a setting up the device. The down key 5 and up key 6 are repeatedly and consecutively manipulated in order to reduce or increase a value.

The hold key 7 serves to temporarily suspend the current operation of the body sculpting device when it is pushed once and to operate again when the start key 8 is pushed. During the holding state, only a key for a corresponding function can be enabled, but other keys for a time setting function, set-up function, and a mode selecting function, etc. are disabled.

The start key 8 allows the body sculpting to start in an automatic set mode or a manually set mode. That is, the start mode is classified as either an automatic start mode or a manual mode (i.e., a recall operating stat mode).

The time set-up key 9 can be set to 30 min as default. The time setting can be adjusted in increments of one minute. The time set-up key 9 can be used to set only time before the start key is pushed but cannot be used during the operation of the body sculpting device. In particularly, while only the holding function is performing, internal time is applied thereto.

The ultra-sonic wave setting key 10 allows a user to select interference waves or free waves, although channel 1 is selected to set an ultra-sonic wave as default. Here, the operation for low-frequency wave (free waves, interference waves) and the operation for ultra-sonic waves can be incompatible, although these two operations can be individually performed. That is, the operation for low-frequency wave (free waves, interference waves) or the operation for ultra-sonic waves can be performed. More specifically, while ultra-sonic waves are generated, the channel cannot change its current ultra-sonic wave frequency to other frequency. The frequency of channel can be changed only before the start key is pushed but cannot be changed after the body sculpting device begins operating.

When the ON/OFF selection key 11 of CH 1 (abdomen) is selected, the ultra-sonic wave as default is first selected but the interference wave and free wave can be selected according to a user's selection. When one of mode A˜F is selected, channel 1 is operated according to the selection. While channel 1 outputs free waves, it cannot change its frequency to interface waves.

The ON/OFF selection key 12 of CH 2 (thighs A and B; channels 2A and 2B) changes the output level, blinking only a corresponding display, at each operation. When the ON/OFF selection key 12 is pushed for a relatively long period of time in order to turn off a corresponding channel during the operation, both channels 2A and 2B are turned off or sequentially turned off. Also, the thigh belt A is indicated by the upper LED and the thigh belt B is indicated by the lower LED. The thigh belts A and B can set their operation sequence according to key inputs: A ON, B OFF->A OFF, B ON->A ON, B OFF->A OFF, B OFF. That is, when a user pushes the key once, thigh belt A is operated and the upper LED is turn on, however, thigh belt B is not operated and the lower LED is turned off. When the user pushes the key again, thigh belt A stops its operation and the upper LED is turned off, however, thigh belt B is operated and the lower LED is turned on.

The ON/OFF selection key 13 of pads and foot plates changes the output levels, blinking a corresponding display, at each operation. When the ON/OFF selection key 13 is pushed for a relatively long period of time during the operation, a corresponding channel is turned off and an ON/OFF signal is output so as to output low-frequency waves to the pads. Here, the body sculpting device is set so that the foot plates output stronger low-frequency waves than the pads.

When a power key located at the lower end is operated to supply power to the probe, the power supply indicative LED is first blinked to indicate that power is now supplied to the probe. When the upper key of the ON/OFF probe selection key 14 is pushed, the probe is ready to operate in the ultra-sonic mode or the vibration mode. Although one of the modes is selected, the selected mode can be altered within 2 minutes from the time of selection. On the contrary, when 2 minutes elapses from the time of mode selection, the power supply indicative LED is continuously turned on until the current state is terminated. That is, the probe can output only one level of ultra-sonic wave and can be operated in one vibration mode. When the ON/OFF probe selection key 14 is pushed for a relatively long period of time during the operation, the probe stops its operation and returns to a state where only a power key is switched on. After that, when an operation power key for supplying power to the probe 300 is pushed, the probe 300 is turned on or off.

The operation of the body sculpting system is described in detail below.

As shown in FIG. 13, the display part 190, backlight unit 192, and indicative LED unit 191 serve to display the operational states of the body sculpting system. The key matrix part 101 inputs key inputs so that the key controller 103 controls the elements. The main controller 105 is liked with the key controller 103 and the drive unit. Also, the main controller 105 is linked with other controllers that control the operations of channels CH 1, CH 2A/2B, CH 3, and CH 4 in a negative feedback method.

### Operation Mode of CH 1

Channel 1 is a terminal connected to a belt to be placed on the user's abdomen. The interference waves and free waves provided through channel 1 burn fat accumulated in the user's abdomen, so that obesity in the abdomen region can be managed. The operation of the body sculpting system according to the present invention is described with reference to FIG. 14.

The ultra-sonic controller 117 of the body sculpting device determines whether a selection signal of channel 1 is input through the main controller 105 (S101). When a selection signal of channel 1 is input, an LED of channel 1 is turned on (S103). After that, it determines whether a key of low-frequency wave (interference wave, free wave) is selected (S105).

When a frequency generation mode is selected at S105, the key controller 103 changes the state of LED, indicative of interference wave generation, from blinking to turning on (S107) and then determines whether a selection key for an ultra-sonic wave is pushed (S109).

When a selection key for an ultra-sonic wave is pushed at S109, the start key is pushed (S117). When a level is set by the down key 5 or up key 6 (S119), the ultra-sonic controller 117 drives the ultra-sonic drive unit 1 (197) and ultra-sonic drive unit 2 (199) so that vibrator 1 (123) and vibrator 2 (125) can be operated at corresponding frequencies, according to the value corresponding to the set level.

On the other hand, when a selection key for an ultra-sonic wave is not pushed at S109, it is determined whether a mode is selected (S115). When a mode is selected at S115 and the start key is selected at S117, a corresponding frequency (interference wave, free wave), selected by the user, is output. Here, the ultra-sonic wave and low-frequency wave (interference wave, free wave) are not simultaneously output. That is, while the ultra-sonic wave is output, the interference wave and free wave are not output, so the body sculpting device can be operated in a stable manner.

As shown in FIG. 7, channel 1 inputs a fixed frequency of 4,000 Hz and a varying frequency of 4,001˜4,150 Hz and thus produces interference waves. Also, free waves of 4,001˜4,150 Hz are produced as a wave of 4,000 Hz changes its duty rate and its amplitude, and then output to the two pads. The wave of a frequency provided to channel 1 is sinusoidal. That is, the wave is converted from a digital signal to an analog signal, so that the waves do not cause any irritation to the user's skin.

Operation Mode of CH 2A and/or CH 2B

Channel 2 is composed of channel 2A and channel 2B. Channel 2A and channel 2B have thigh belts to be worn on the thighs, respectively. The waves of a frequency, output from channels 2A and 2B, burn fat accumulated in the user's thighs. That is, the sub-controller 129 inputs the free waves from the main controller 105 and outputs them to four pads of a corresponding channel, which are serially connected. The sub-controller 129 of channel 2 is connected to the two channels, but the main controller 105 performs the majority of the determination for all outputs of the two channels.

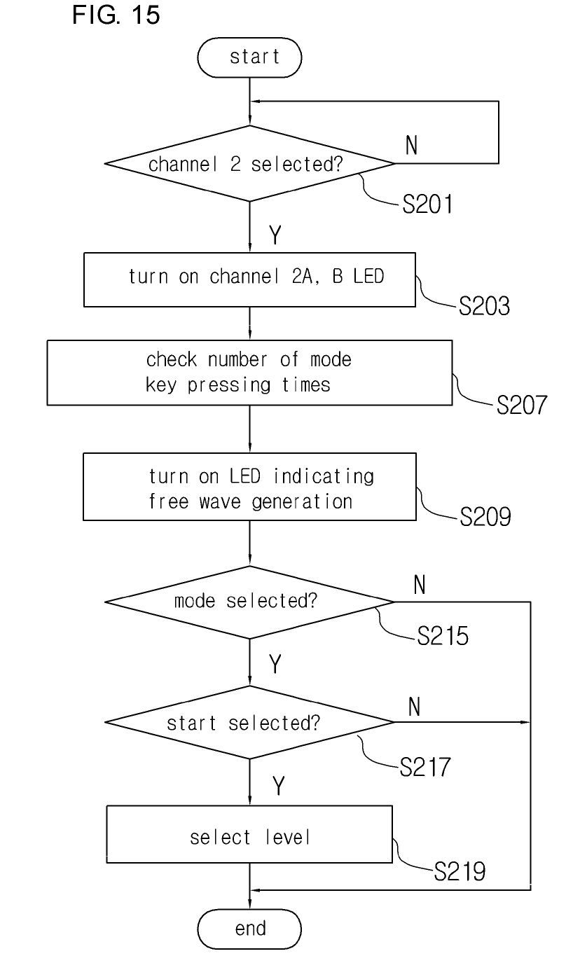

As shown in FIG. 15, the main controller 105 determines whether a selection signal for channel 2 is input (S201). When a selection signal for channel 2 is input at S201, the main controller 105 changes the state of the selection indicative LED of channel 2A and channel 2B from a blinking state to a turning on state (S203). After that, the main controller 105 checks whether a user selects a mode to operate pads A and B of channel 2 (S207). When a mode to operate pads A and B of channel 2 is selected at S207, a low-frequency indicative LED is turned on (S209).

Here, A and B are referred to as channel 2A and channel 2B, respectively. At the mode selection of S207, channel 2A and channel 2B are sequentially selected according to the pushing sequence of the ON/OFF selection key 12 of channel 2. For example, according to the pushed number of the ON/OFF selection key 12 of channel 2A, four processes, A ON, B OFF mode->A OFF, B ON mode->A OFF, B ON mode->Both A and B OFF, can be set.

When the user selected the free wave and the mode so as to output a corresponding mode, the sub-controller 129 determines whether a start key 8 is selected (S217). When a start key 8 is selected at S217, the sub-controller 129 provides free waves to A and/or B of channel 2 and both A and B (S219).

When a jack is not connected to channel 2A, the sub-controller 129 provides the free waves, output from channel 2A, to the foot plate pads 115 of the lower portion of the hardware of the body sculpting device.

The free waves, provided to A and/or B of channel 2 and/or both A and B of channel 2, are sinusoidal.

### Operation Mode of CH 3

Channel 3 is configured to include an attaching pad 135 and a ring pad (not shown) which can be attached to the area that a user wishes to target. Channel 3 provides low-frequency waves to the foot plate pad 115 located on the lower portion of the hardware of the body sculpting device, on which the user's feet are positioned.

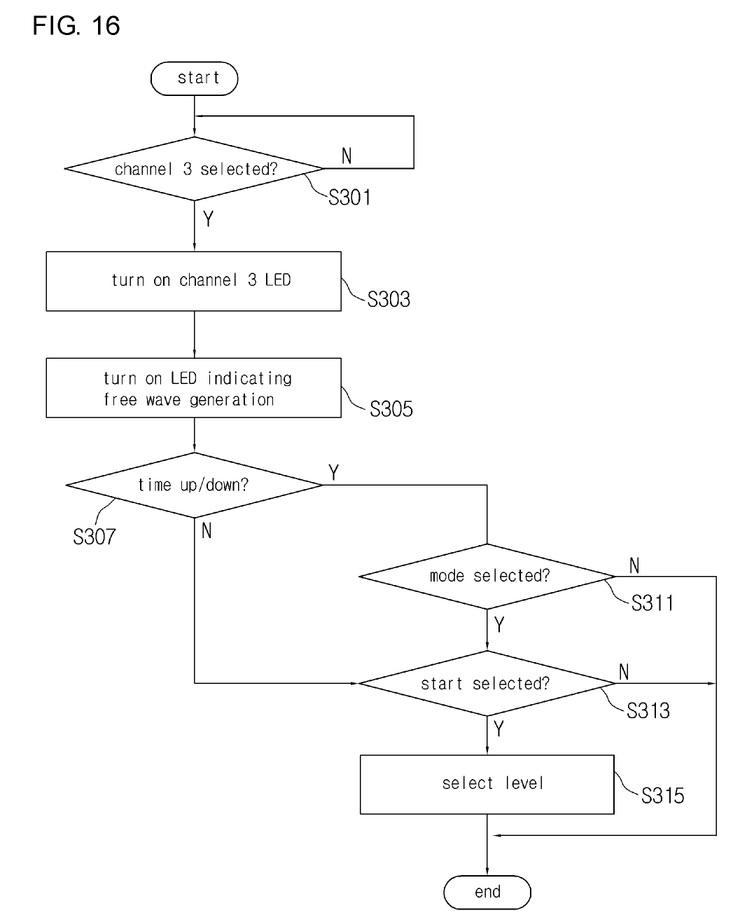

As shown in FIG. 16, the main controller 105 determines whether a selection signal of channel 3 is input through the key controller 103 (S301).

When a selection signal of channel 3 is input at S301, the main controller 105 turns on the LED indicating that channel 3 is selected (S303). After that, the main controller 105 turns on the LED indicating that a low-frequency wave has occurred (S305) and determines whether the frequency level of waves output to the pads, connected to the selected channel 3, is set (S307).

When the frequency level is set at S307, the main controller 105 determines whether a mode is set (S311). That is, when a frequency level and a mode are set, the main controller 105 changes the current mode to a corresponding mode and then determines whether a start key is selected (S313). When a start key is selected at S313, the main controller 105 provides the wave of the frequency to channel 3 (S315).

Channel 3 can employ the ring pads or the attaching pads. The low-frequency waves provided to channel 3 are sinusoidal.

### Operation Mode of CH 4

Channel 4 is connected to the probe 300. Channel 4 inputs power according to operation signals output from the main controller 105. The A/D converter 137 converts an analog signal, representing the current variation, into a digital signal, according to the operation of the probe. The digital signal is transmitted to the key controller 103 through the main controller 105. After that, the digital signal as a probe output value is displayed on the display part 190. The probe 300 is used to intensively massage a particular part of body with a small surface area, such as the face, etc.

The probe 300 is configured to include an ultra-sonic generator 310 and a vibration motor 320. A user can select and operate one of either the ultra-sonic generator 310 or vibration motor 320 and massage the desired body part, such as the face, etc.

The ultra-sonic generator 310 is placed at the upper end of the probe 300. In a state where the power button is turned on and a button for selecting an ultra-sonic wave and a vibrator is then pushed, when the ultra-sonic operation button 311, installed to the outer body of the probe 300, is switched on, the ultra-sonic generator 310 operates for five minutes and generates ultra-sonic waves.

The vibration motor 320 is installed in the body of the probe 300. In a state where the cap 323 is coupled to the upper end of the ultra-sonic generator 310, when the power button is turned on and the vibration operation button 321 is then selected, the vibration motor 320 inputs power and then vibrates, so that the probe 300 is vibrated.

Meanwhile, the MODES A˜F described above is explained in more detail below.

MODE A allows the body sculpting device to output waves of 1˜15 Hz at 3 second intervals, i.e., 1, 3, 5, 7, 9, 11, 13, and 15 Hz. MODE B allows the body sculpting device to output waves of 80˜150 Hz at 3 second intervals, i.e., 80, 90, 100, 110, 120, 130, 140, and 150 Hz. MODE C allows the body sculpting device to output waves of 1˜80 Hz at 3 second intervals, i.e., 10, 20, 30, 40, 50, 60, 70, and 80 Hz. MODE D allows the body sculpting device to output waves of 100˜150 Hz at 5 second intervals, i.e., 100, 125, and 150 Hz. MODE E allows the body sculpting device to output waves of 1˜15 Hz at 5 second intervals, i.e., 1, 5, 30, 45, 60, 75, 90, 105, 120, 135, and 150 Hz. MODE F allows the body sculpting device to randomly output waves of 80˜150 Hz at 5 second intervals, for example, 1-4,080˜4,090 Hz, 2-4,091˜4,100 Hz, 3-4,101˜4,110 Hz, 4-4,111˜4,120 Hz, 5-4,121˜4,130 Hz, 6-4,131˜4,140 Hz, and 7-4,141˜4,150 Hz, according to the pointer.

As described above, the body sculpting system, according to the present invention, includes a control box, a stand, an obesity management unit, a probe, etc., so that fat accumulated in the user's abdomen, thighs, arms, etc. can be effectively burnt by the obesity management unit.

Also, a user can massage the soles of the user's feet through a mid-frequency generator formed on the foot plates of the stand and the user's face through the probe exerting an ultrasonic wave emission function and vibration function, which can be selected by the user.

Although exemplary embodiments of the present invention have been described in detail herein above, it should be understood that many variations and modifications of the basic inventive concept herein described, which may be apparent to those skilled in the art, will still fall within the spirit and scope of the exemplary embodiments of the present invention as defined in the appended claims.

What is claimed is:

1. A body sculpting device comprising:
a control box (200) that includes a cover (210), a small-sized auxiliary cover (220) installed on the front of the cover (210), and a control unit (230) that is exposed when the auxiliary cover (220) is opened from the cover (210), the control box (200) controlling a plurality of elements through the control unit (230) electrically connected thereto;
a stand (400) that includes amid-frequency generator (420) installed to foot plates (470) on which user's soles are placed, the stand (400) allowing the mid-frequency generator (420) to stimulate the user's soles when a connector (450), electrically connected to the mid frequency generator (420), is connected to a coupling unit (201) formed at the rear of the control box (200);
an obesity management unit (100) that includes a mid-low frequency generator (120) and an ultra-sonic generator (140) which are installed to the front of a synthetic resin plate (110) shaped as a plate by an ejection method, the obesity management unit (100), electrically connected to the control unit (230) of the control box (200), burning fat in the user's abdomen, thighs, arms, etc. and promoting blood circulation; and
a probe (300) that includes an ultra-sonic generator (310) installed on its upper end and a vibration motor (320) installed within its body, the probe (300), electrically connected to the control box (200), massaging the user's face by using the ultra-sonic generator (310) or the vibration motor (320).

2. The body sculpting device according to claim 1, wherein:
the control box (200) includes an auxiliary cover (220) formed on the front thereof; and
the control box (200) is configured to disclose the control unit (230) including a display window (231) and function buttons (232), and connection terminals (233) to which the obesity management unit (100), the probe (300), and pads (101), which stimulate user's body, are electrically connected.

3. The body sculpting device according to claim 1, wherein the stand (400) comprises:
an interference protection groove (430) that is formed at the rear side on the bottom of a support (410) placed at the upper part so as to prevent a connector (450) from being damaged when the control box (200) is placed in the support (410) in a state where the connector (450) is electrically connected to the control box (200); and
a reserved interference protection groove (440) that is formed at the middle portion on the bottom of the support (410) so as to prevent the connector (450) from interfering with the outside when the connector (450) is separated from the control box (200).

4. The body sculpting device according to claim 1, wherein the obesity management unit (100) comprises a synthetic resin plate (110) of a certain size, in which the synthetic resin plate (110) is configured in such a way that:
a coupling groove (121) for a mid-low frequency generator and coupling grooves (122) for protection covering, which are extended through the body of the synthetic resin plate (110) and formed at both left and right sides of the synthetic resin plate 110;
a locking groove (142) for an ultra-sonic generator and a coupling part (141) for protection covering, which are formed on the front and rear sides at the middle portion of the synthetic resin plate (110);
the mid-low frequency generator (120) and the ultra-sonic generator (140) are detachably assembled to the front of the synthetic resin plate (110) through the coupling groove (121) for the mid-low frequency generator and the coupling grooves (122) for ultra-sonic generator; and
protection covers (130 and 131) are detachably assembled to the rear side of the synthetic resin plate (110), so that the protection covers (130 and 131) can protect the insides of the mid-low frequency generator (120) and the ultra-sonic generator (140) through the coupling grooves (122) for protection covering and the coupling part (141) for protection covering.

5. The body sculpting device according to claim 4, wherein the synthetic resin plate (110) forms a plurality of folding grooves (180) at the rear side thereof, which are spaced apart from each other at a certain distance, in which the folding grooves (180) allow the synthetic resin plate (110) to be naturally bent along the user's body shape.

6. The body sculpting device according to claim 4, wherein the obesity management unit (100) comprises a circuit board (160) installed thereto.

7. A body sculpting system comprising:
a key controller (103), wherein the key controller (103) includes a controller that determines whether a channel is selected through the key matrix part (101) and whether the selected channel is operated, inputs a key value from the key matrix part (101) and displays a corresponding state of the display part (190), controls driver controllers of respective drives included in a drive unit, and transmits digital signals output from the outside to the display part (190) to display output values in real-time;
a storage unit (107) for storing a body sculpting program;
a main controller (105) that determines whether a key input corresponds to a signal to select one of four channels, reads, in a negative feedback manner, whether a frequency generated through the selected channel is selected and performs a negative-feed back control so that the selected frequency can be generated through the selected channel, determines a mode selected by a user to read the selected mode from the storage unit (107) and performs a controlling operation so that the whole system can be driven to the corresponding mode;
a drive unit that drives two of four pads associated with channel 1 to generate the fixed frequency of 4 kHz according to the control of the main controller (105), varies the duty rate and amplitude, according to the program stored in the storage unit 107, to drive the remaining two pads associated with channel 1 to generate free waves, or drives four pads to output interference waves;
an ultra-sonic controller (117) that outputs the interference waves or free waves to channel 1 according to the frequency output from the drive unit; and
a sub-controller (129) that provides only the free waves to channels (2A, 2B, and 3) with respect to the frequency signal output from the drive unit.

8. The body sculpting system according to claim 7, wherein the drive unit comprises:
a free wave drive unit (109) for varying the duty rate and amplitude according to the control of the main controller (105); and
an interference wave drive unit (111) for generating interference waves, according to the control of the main controller (105).

9. The body sculpting system according to claim 7, wherein the main controller (105) switches the jack of the channel (2A) to provide a frequency to foot plate pads.

10. The body sculpting system according to claim 7, wherein the interference waves, provided to the channel 1, are generated by the frequency difference between a fixed frequency of 4,000 Hz and a varying frequency of 4,001˜4,150 Hz.

11. The body sculpting system according to claim 7, wherein the output wave, provided to the channel (1) or channel (2), is sinusoidal, in which the output wave is generated as a digital signal that is converted to an analog signal.

12. The body sculpting system according to claim 7, wherein the ultra-sonic controller (117) outputs ultra-sonic waves according to a ultra-sonic level output from the main controller (105).

13. The body sculpting system according to claim 7, wherein the main controller (105) is switched on, determines whether a cooling fan (500) is connected thereto, and controls the whole system so that the body sculpting device can be operated when the cooling fan (500) is connected thereto.

14. The body sculpting system according to claim 7, wherein the main controller (105) determines whether a belt is coupled thereto when a channel selection signal is input, allows the body sculpting device to operate when the belt is coupled thereto, checks whether the belt is coupled during the operation of the body sculpting device, detects whether the belt is not connected thereto during the operation of the body sculpting device, and stops the operation when the belt is released therefrom.

15. The body sculpting system according to claim 7, wherein the main controller (105) sequentially and automatically performs from level 1 to level 15 when an automatic level mode is selected and allows a user to select one of 18 levels when a manual level mode is selected.
